(19) United States
(12) Patent Application Publication
(10) Pub. No.: US 2013/0197952 A1
(43) Pub. Date: Aug. 1, 2013

(54) PRODUCT PRODUCIBLE NUMBER CALCULATION APPARATUS AND COMPUTER-READABLE RECORDING MEDIUM

(71) Applicant: HITACHI, LTD., Tokyo (JP)

(72) Inventors: Tazu NOMOTO, Yokohama (JP); Keiji MATSUMOTO, Tokyo (JP)

(73) Assignee: HITACHI, LTD., Tokyo (JP)

(21) Appl. No.: 13/685,916

(22) Filed: Nov. 27, 2012

(30) Foreign Application Priority Data
Feb. 1, 2012 (JP) 2012-019424
Jul. 26, 2012 (JP) 2012-165326

(51) Int. Cl. G06Q 10/06

(52) U.S. Cl. CPC G06Q 10/0631
USPC 705/7.12

(57) ABSTRACT

An apparatus having a processing unit for using information stored in a storage unit to calculate a producible number of each item is disclosed. The processing unit sets up a steady mode or a non-steady mode based on input information or the information stored in the storage. The processor unit operates, in the steady mode, to calculate a producible number by using a supply path stored in a supply path storage unit. In the nonsteady mode, the processor sets up a time taken for an item to be moved between hubs not being stored in the supply path storage unit, and repeatedly computes, from end-piece parts of an item configuration up to the product, a quantity of a parent item having the item as its component when this item is transferred between the hubs by use of an inventory or work-in-process quantity, thereby calculating the product producible number.

### INCORPORATION BY REFERENCE

The present application claims priorities from Japanese applications JP2012-019424 filed on Feb. 1, 2012 and JP2012-165326 filed on Jul. 26, 2012, the contents of which are hereby incorporated by reference into this application.

### BACKGROUND OF THE INVENTION

The present invention relates to a method and apparatus for calculating a producible number of a product which is manufactured by combination of at least one or more parts or materials (referred to as members hereinafter) based on inventory quantities and procurement schedules of these members.

Usually, what serves as a trigger for production planning is data concerning products to be delivered to customers, such as a sales plan, demand forecast and order entry information to be provided from a manufacturer's sales/marketing department. A person in charge of the production planning draws up a production plan so as to deliver finished products on a just-in-time basis, and prepares members needed for the production. Upon occurrence of any changes in the sales plan or the like, the production plan is also revised accordingly in order to avoid useless inventory and delivery delay. Regarding a technique for making and changing a production plan based on product demand, many approaches have been proposed until today.

However, the necessity to make and change a production plan can take place not only due to a change in product sales plan but also due to troubles occurring during manufacturing and/or delivery delay of members required. If this is the case, a need is felt to confirm the number indicative of a manufacturable or producible quantity—say, producible number—of a product from inventory quantities of members and production progress and to make/revise a feasible production plan while recognizing the influence on the sales plan.

Other needs for obtainment of the producible number of the product from requisite members include a delivery reply, known as the capable to promise (CTP). An example of prior known CTP-managing methods is to send a reply accepting the deadline of delivery by applying an order to the number indicative of day-by-day order acceptability of such product. In cases where this per-date product order acceptability number is absent, the deadline reply is prosecutable if a producible number is determined from inventory quantities of members and production situation.

One example of the technique for determining through computation a producible number from member inventory quantities and production status is disclosed in U.S. Pat. No. 7,123,977. A method as taught thereby is for use in productivity management of a plurality of types of products including a common component(s), wherein the method is arranged to calculate, per product type, a numerical value indicating how many products are manufacturable in excess of the required number or, alternatively, compute a maximum producible number thereof.

In a case where there is a shipment plan, the so-called material requirements planning (MRP) scheme is used to perform requisite quantity calculation for accommodation of necessary members of the product in order to execute the shipment plan while satisfying a designated date and delivery quantity. MRP processing methodology per se is discussed in Leighton F. Smith, “Theory & Practice of MRP,” translation by Y. Kojima and M. Mori, published by Japan Management Association (JMA), 1977, pp. 8-13. One example of a manufacturing productivity management system using the MRP scheme is disclosed in JP-A-2000-79542.

### SUMMARY OF THE INVENTION

In the case of calculating a producible number of a product from inventory quantities of members, it is required to give, as input information, a flow of things along transportation routes covering from reception of incoming members up to completion of product manufacturing (i.e., which member is to be produced at which place with consumption of what length of time and, thereafter, will be transported to what place with elapse of how much time). Such information indicating the flow of things will be called the “supply path” for the sake of convenience.

Recent advances in globalization lead to an increase in work complexity relating to procurement, production, reposition (warehouse) and selling bases or hubs. Concerning a product demanded in various parts of the world, its manufacturing and repositing hubs are typically located at nearby sites of a demand center to thereby build up a system with fast deliverability while reducing commodity distribution costs.

As such hubs increase in number to exhibit extended geographic coverage, the risk of supply cut-off accidents is becoming higher, which takes place due to political uncertainty and natural disasters, such as irregular occurrence of earthquakes and floods of seawater in various locations. Even for a small risk which occurs once in decades at a site, this will possibly cause serious supply cutoff accidents somewhere at any given time in the case of the system having an extensive supply chain including a large number—e.g., 50 to 100—of hubs as a whole. In case the supply cutoff is recoverable within a few days, no specific programs occur; however, if it continues for a long time, product manufacturing and selling activities must be damaged. To minimize such damage, it is required to clarify the influence on products and also to take corrective measures immediately. For example, when a certain kind of members become unavailable, an attempt is made to specify what type of products use such members and to verify how many products are manufacturable using a currently available inventory quantity of members of this kind. A producible number at this time is calculated not only by using the information on inventory quantities existing on the supply path in steady events but also by taking account of a chance to transfer in-stock members at other hubs. By doing so, it is possible to attain an increased production quantity.

To calculate the producible number by giving consideration to inventory quantities of all hubs, the aforementioned calculation method of U.S. Pat. No. 7,123,977, for example, is required to prepare as input information the information of a supply path with transferability. In case products and members are less in type with the hubs being less in number, a total information amount is not so much; however, when the product type and members increase as in precision equipment, land vehicles or else, the number of supply paths becomes extremely large. Even if such supply path information is created with the aid of a software program, producible number calculation using it as input data by a computing machine, such as personal computer (PC), would result in deficiency of a memory capacity. Another problem faced with the prior art is as follows: when the shutoff supply path is recovered, it is needed to return to the steady-time supply path; however, this must be done to make sure that the supply path is maintained in the latest circumstance at all times because it is an ordinary way to recover the supply path gradually from its one part to another.

The present invention has been made in view of the above-stated technical background, and a first object of the invention is to enable calculation of a producible number using a utilizable supply path even in nonsteady events, such as supply cutoff accident or the like.

Another risk associated with advances in globalization is a sudden change in demand, which is considered to be serious in the same level as the supply path shutoff risk. As in the supply cutoff, an incremental or decremental change in sales volume due to economic fluctuation is also occurrable at a hub or hubs at any time. Especially, in case the shipment plan of a hub 1 is suddenly changed to increase a shipment quantity, production using only the conventional supply path can result in shortage of members. If there is another hub 2 which decreases in sales volume or which has enough time before its delivery due date, this hub's arranged members are transferred to the hub 1 whereby the shortage disappears and, simultaneously, surplusage of members is avoidable. Similar problems can also occur due to not only such sudden demand change but also a variation in production capacity caused by sudden occurrence of troubles at production facilities. It is a realistic way to make a will decision, after having confirmed that profitability is sustained, based on a cost needed for transportation and a profit obtained by satisfying a for-sale shipment plan.

This invention has been made in view of the above-stated background, and it is a second object of the invention to enable calculation of a producible number and cost using a utilizable supply path(s).

To attain the first object of the invention, a producible number calculation apparatus for calculating a producible number of a chosen type of products to be manufactured by combining a plurality of items is provided, which is arranged to set up a steady mode or a non-steady mode based on information inputted thereto or the information stored in a storage unit, calculate in the steady mode the producible number by using a supply path stored in a supply path storage unit, and set up in the nonsteady mode a time for transfer of an item between hubs which are not stored in the supply path storage unit and repeatedly computes, from end parts of the item configuration up to the product, a quantity of a parent item having the item as its constituent part when this item is transferred between the hubs by use of the inventory or the work-in-process quantity to thereby calculate the producible number of the product.

Additionally, in order to attain the second object of the invention, the apparatus is configured to further include a hub-to-hub or “inter-hub” cost storage unit storing therein a cost taken for transfer between hubs, wherein the apparatus operates in the nonsteady mode to set up a time for transfer of an item between hubs not being stored in the supply path storage unit and to repeatedly calculate, from end-piece parts of the item configuration up to the product, a quantity of a parent item having the item as its component and a cost thereof when this item is transferred between the hubs by use of the inventory or the work-in-process quantity to thereby calculate the producible number of the product and the cost.

According to this invention, it is possible even in nonsteady events to achieve the calculation of a producible number using a utilizable supply path, thereby making it possible to take a rapid counter measure for securement of a production quantity. Additionally in steady events, it is possible to compute a usable supply path and producible number plus cost, thereby enabling achievement of production planning while taking account of flexibility between hubs.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration of a producible number calculation apparatus in accordance with one preferred embodiment of the present invention.

FIG. 2 is a diagram showing a flow of “things” for the purpose of explaining the producible number calculation apparatus in accordance with one embodiment of this invention.

FIG. 3 is a diagram showing a structure tree of items for explanation of an operation of the producible number calculation apparatus in accordance with one embodiment of this invention.

FIG. 4 is a diagram showing hub information for explanation of an operation of the producible number calculation apparatus in accordance with one embodiment of this invention.

FIG. 5 is a diagram showing supply path information for explanation of an operation of the producible number calculation apparatus in accordance with one embodiment of this invention.

FIG. 6 is a diagram showing production information for explanation of an operation of the producible number calculation apparatus in accordance with one embodiment of this invention.

FIG. 7 is a diagram showing inventory information for explanation of an operation of the producible number calculation apparatus in accordance with one embodiment of this invention.

FIG. 8 is a diagram showing work-in-process information for explanation of an operation of the producible number calculation apparatus in accordance with one embodiment of this invention.

FIG. 9 is a diagram showing a processing flow of a processing unit which calculates a producible number for explanation of an operation of the producible number calculation apparatus in accordance with one embodiment of this invention.

FIG. 10 is a diagram showing a processing flow of the processing unit which performs supply path generation and producible number calculation for explanation of an operation of the producible number calculation apparatus in accordance with one embodiment of this invention.

FIG. 11 is a diagram showing an exemplary display image on the screen of a display device for explanation of an operation of the producible number calculation apparatus in accordance with one embodiment of this invention.

FIG. 12 is a diagram showing one example of a supply time input window on the display screen for explanation of an operation of the producible number calculation apparatus in accordance with one embodiment of this invention.

FIG. 13 is a diagram showing shipment plan information for explanation of an operation of the producible number calculation apparatus in accordance with one embodiment of this invention.

FIG. 14 is a diagram showing producible number information for explanation of an operation of the producible number calculation apparatus in accordance with one embodiment of this invention.

FIG. 15 is a diagram showing a hardware configuration example of the producible number calculation apparatus in accordance with one embodiment of this invention.

FIG. 16 is a diagram showing a configuration of a producible number calculation apparatus in accordance with another embodiment (second embodiment) of this invention.

FIG. 17 is a diagram showing item-related cost information of hub-to-hub or “interhub” cost information for explanation of an operation of the producible number calculation apparatus in accordance with the second embodiment of this invention.

FIG. 18 is a diagram showing hub-related cost information of the interhub cost information for explanation of an operation of the producible number calculation apparatus in accordance with the second embodiment of this invention.

FIG. 19 is a diagram showing cost upper-limit information for explanation of an operation of the producible number calculation apparatus in accordance with the second embodiment of this invention.

FIG. 20 is a diagram showing a processing flow of a producible number-calculating processor unit for explanation of an operation of the producible number calculation apparatus in accordance with the second embodiment of this invention.

FIG. 21 is a diagram showing a processing flow of a processing unit which generates a supply path and which calculates a producible number and cost, for explanation of an operation of the producible number calculation apparatus in accordance with the second embodiment of this invention.

FIG. 22 is a diagram showing cost information for explanation of an operation of the producible number calculation apparatus in accordance with the second embodiment of this invention.

FIG. 23 is a diagram showing an on-screen display example of a display device for explanation of an operation of the producible number calculation apparatus in accordance with the second embodiment of this invention.

FIG. 24 is a diagram showing one example of a cost input window for explanation of an operation of the producible number calculation apparatus in accordance with the second embodiment of the invention.

### DESCRIPTION OF THE EMBODIMENTS

### Embodiment 1

A producible number calculation apparatus in accordance with one embodiment of the present invention will be described with reference to the accompanying drawings below.

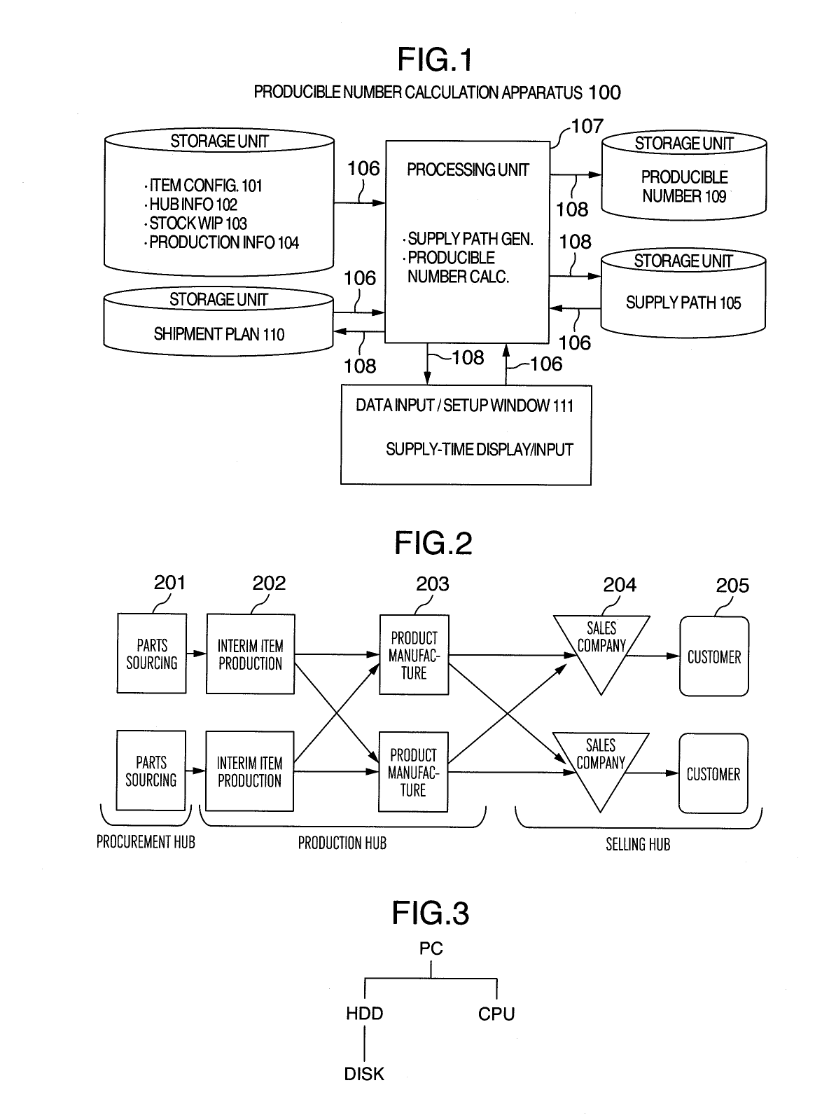

An explanation will first be given, using FIG. 2, of a flow of things from a manufacturing base point, also known as production hub, to a selling site or hub. At the production hub, several works are performed, including procurement (201) of parts or components, production (202) of large-structure semimanufactured products from the parts, production (203) of finished products from such semimanufactured ones, and shipment of these products, which are once delivered to sales companies (204) existing at selling hubs and then distributed to customers (205). In cases where the products are not assemblies, for example, in the case of food oil or like substance, wherein the aforesaid component corresponds to crude, the semimanufactured product is purified oil, and the finished product is a bottle of oil, the generality is not lost if the component and the semimanufactured product are reworded as a raw material and an intermediate product, respectively. The product supply of from the production hub to selling hub may alternatively be performed from a plurality of production hubs. Regarding supply means, it may have a plurality of ways different in transportation cost and supply time, such as a ship and airplane, an ordinary delivery and express delivery, etc.

Generally, products manufactured by a company have a plurality of types, and component configurations to be dealt in the assembly type have multiple stages and complicated structures. As for process-type products, a manufacturing process number exceeds one hundred in some cases; so, a great amount of processing is required to handle actual products. In this embodiment, in order to clearly show the subject matter of this invention, an explanation will be given while simplifying the type/kind of a product, component configuration and process number.

Also note that the term “process” as will be used in the description of this embodiment may also be a facility or a worker or an aggregation thereof. A plant or factory may be regarded as a single process. Generally, the manufacturing industry is often such that facilities and workers are managed in the form of an ensemble (organization) for certain reasons, such as labors and prime costs; thus, such ensemble may be regarded as the “process.”

A producible number calculation apparatus 100 in this embodiment will be explained with reference to FIG. 1. This apparatus is constituted from an item configuration storage unit 101 which stores therein a configuration table of those items used to manufacture a product, a hub information storage unit 102 which stores therein production and reposition sites (base points or hubs) of the items including the product, an inventory/work-in-process storage unit 103 which stores therein a per-site inventory and work-in-process (WIP) quantity of each item, a production information storage unit 104 that stores a per-site production time of each item, a supply path storage unit 105 that stores data indicative of a time taken for an item to move from its original site (hub) 1 to another site (hub) 2, a data input unit 106 which receives data from a storage unit and stores it in a memory, a processing unit 107 which generates a hub-to-hub transfer time and which calculates producible number, a data output unit 108 which outputs the calculated producible number from the memory to storage unit, and a storage unit 109 that stores one or more producible numbers. As need arises, the apparatus may also be arranged to further include a shipment plan storage unit 110 storing therein per-date/site-by-site shipment quantities of the items and a functional module which displays on a video screen a data input/setup window 111 showing the length of a supply time while allowing a user to manually input it.

FIG. 15 is a diagram showing an exemplary hardware configuration of the producible number calculation apparatus 100 of this embodiment. The calculation apparatus 100 is a digital computer, examples of which include, but not limited to, a personal computer (PC), workstation and server device.

The producible number calculation apparatus 100 has an input device 301, output device 302, external storage device 303, arithmetic processing device 304, main storage device 305, communication device 306, and system bus 307 for interconnection of these respective devices.

The input device 301 is an input data accepting device, such as for example a keyboard, mouse, touch pen or other pointing devices. The output device 302 is a video display device, such as a flat-panel display monitor for example. The external storage device 303 is a nonvolatile storage, such as for example a hard disk drive (HDD), a flash memory or else. The processing device 304 may typically be a central processing unit (CPU).

The main storage device 305 is a semiconductor memory device, such as a random-access memory (RAM) for example. The communication device 306 is a wireless communication device which performs communications through an antenna or, alternatively, a wired communication device that performs online communications via a network cable. The storage unit of the producible number calculation apparatus 100 is practically implemented by any one of the main storage device 305 and external storage device 303 thereof.

Note here that the input unit, processing unit and output unit of the producible number calculation apparatus 100 are realizable by a computer-executable software program for causing the processor unit 304 to execute the processing.

This program is stored in either the main storage device 305 or the external storage device 305 and is loaded into the main storage device 305 upon execution and is then executed by the processing unit 304. Additionally, the producible number calculation apparatus 100 is arrangeable to have the communication device 306 as needed, for performing transmission and reception of information via the communication device 306. One conceivable exemplary form is as follows: the storage unit relating to production and procurement of parts or components is built in a device to be managed by a procurement hub; the storage unit concerning production of intermediate products and finished products is built in a device under management of a production hub; the storage relating to selling activities is built in a device being managed by a selling hub; and, the processing unit for performing computation and for outputting calculation results is built in a device managed by an information division of manufacturer.

An operation of the producible number calculation apparatus 100 of this embodiment will be set forth using appropriate illustrative examples on a case-by-case basis. FIG. 3 shows a component configuration of a product—here, personal computer (PC). A single unit of the product “PC” is manufactured using one unit of interim product “HDD” and one unit of component “CPU.” The one unit of interim product “HDD” is produced using one unit of component “DISK.” The data shown in FIG. 3 is stored in the item configuration storage unit 101.

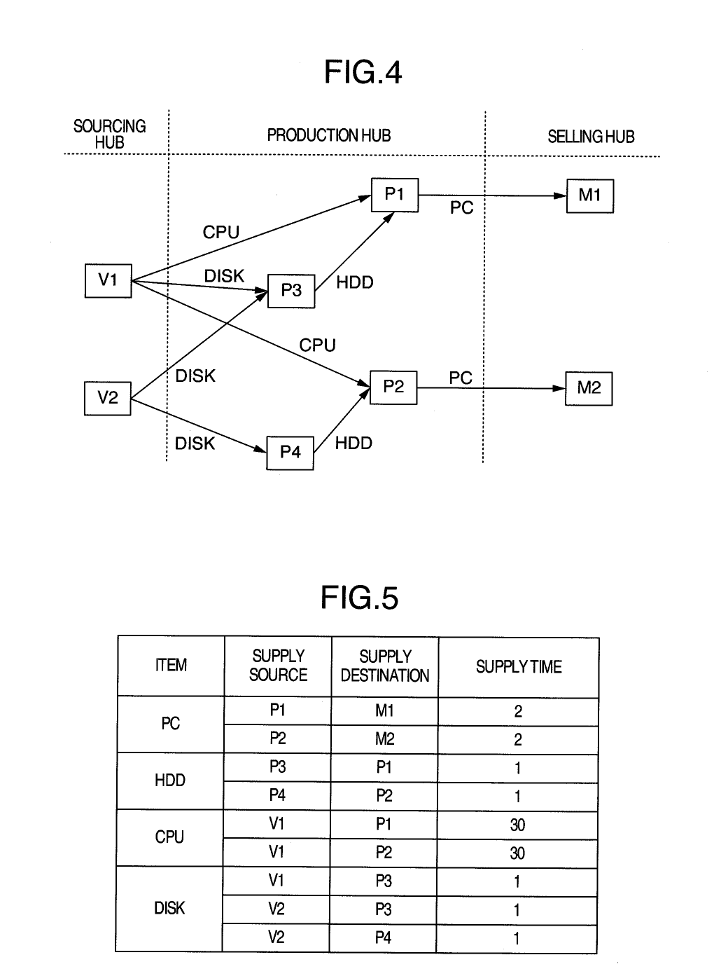

As shown in FIG. 4, the base points involved include a couple of PC-selling hubs M1 and M2, two PC production hubs P1-P2, two HDD production hubs P3-P4, and CPU/DISK-procuring hubs V1-V2 (called the procurement hubs). Supply paths among these hubs are indicated by arrows. PCs to be supplied to the selling hub M1 are manufactured at the hub P1 using CPUs procured at hub V1 and HDDs produced at hub P3 using DISKs acquired at hubs V1-V2. PCs supplied to the selling hub M2 are produced at the hub P2 using CPUs procured at hub V1 and HDDs made at hub P4 using DISKs sent from hub V2.

FIG. 5 shows in table form a list of supply times (supply lead times) of respective supply paths. For example, the first row of the table of FIG. 5 has a registration indicating that two periods are needed to transport the item PC from the supply source hub P1 to the supply destination hub M1. The data shown in FIG. 5 is stored in the supply path storage unit 105.

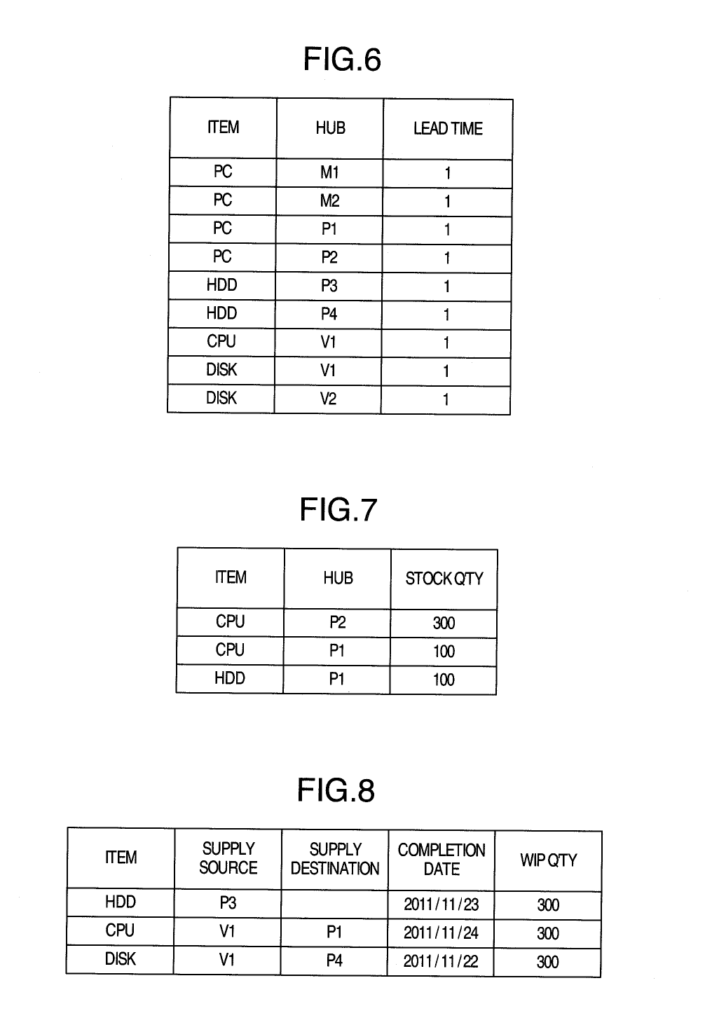

In the items to be handled at respective hubs, lead times required for processing, such as production, stock-intake, etc., are defined as shown in FIG. 6. The data shown in FIG. 6 is saved in the production information storage unit 104. Optionally, in cases where the workload at each hub is utilized for restriction at the time of producible number calculation, the production information storage unit 104 may further have a per-item hub-by-hub work time per unit and a per-period operation-capable time of each hub.

Inventory information of items to be handled at respective hubs is shown in FIG. 7, and work-in-process (WIP) information is shown in FIG. 8. This information is stored in the inventory/work-in-process storage unit 103.

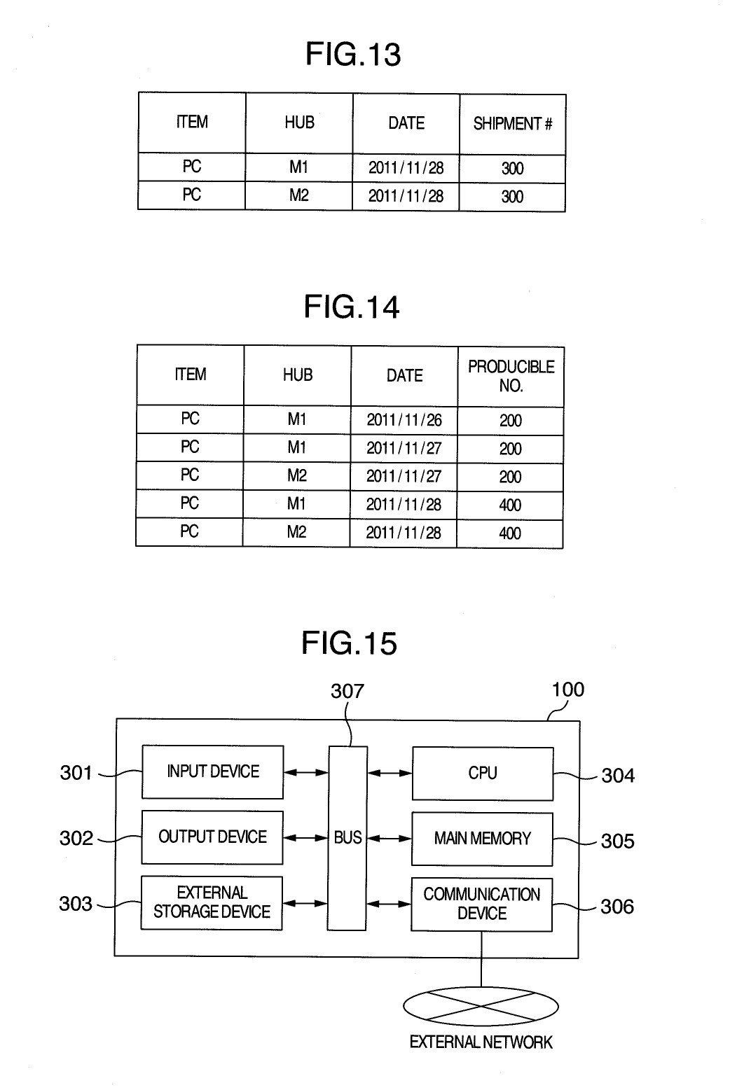

A plan of shipment from each hub is shown in FIG. 13. The shipment plan is the one that registers therein the due date and quantity of products to be delivered to a site(s) other than those registered in the hub information storage unit 102. The data shown in FIG. 13 is stored in the shipment plan storage unit 110.

The above-stated information is saved in the memory by the data input unit 106, based on which the processing unit 107 generates a supply path and computes a producible number. The resulting supply path and producible number are output by the data output unit 108 from the memory to corresponding storage units.

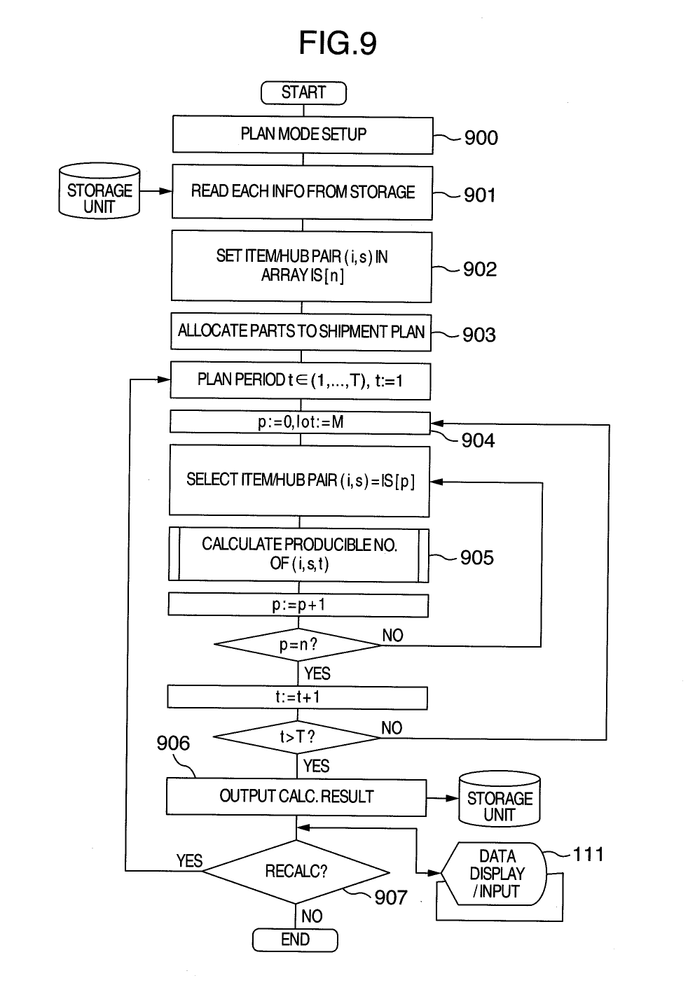

The data input unit 106, processing unit 107, data output unit 108 and on-screen input/setup window generator 111 perform processing operations using the CPU and memory through several steps shown in FIG. 9.

Processing operations at respective steps will be set forth below.

### <Step 900>

The processing unit 107 sets up a plan mode. The plan mode has two options: “steady” and “nonsteady.” In the steady mode, the processing unit 107 uses a supply path being registered in the supply path storage unit 105 to calculate a producible number. In the nonsteady mode, it generates a supply path which is not registered in the supply path storage unit 105 when the need arises and calculates a producible number. This plan mode will be used at step 905.

The plan mode setup may alternatively be a process having the steps of inputting setup information to the external storage device 303, registering it thereto, reading it when needed, and making a decision. For example, the user may input in response to receipt of the information saying that the supply path of interest is currently in a cut-off or disruption state. Another method may be employed, which has the steps of checking supply time data of the supply path storage unit 105, finding a path with the need for consumption of a time longer than usual, presuming that such path is in disruption, and setting up the nonsteady mode. In the nonsteady mode, a process is performed for specifying the disruption occurring at the stored supply path and for generating a new supply path in place of such disrupted supply path. A detailed explanation of it will be given at subsequent steps.

### <Step 901>

The data input unit 106 reads input information 101-105 and 110 needed for calculation from corresponding ones of the storage units into the memory.

### <Step 902>

An operation is performed to extract from the item configuration that was read out of the item configuration storage unit a specific item which is at the top of such configuration. In the example of FIG. 3, this item is PC. Next, production information is read out of the production information storage unit, from which information is extracted an item and/or hub with the item having been registered thereto; then, the item/hub is set in an array IS for storage of items and hubs being subjected to calculation. Next, concerning the shipment plan that was read from the shipment plan storage unit, if there is a currently registered item/hub pair other than the prior extracted item/hub pairs, the pair is set in the array IS. In the examples shown in FIG. 6 and FIG. 13, four pairs (PC,M1), (PC,M2), (PC,P1) and (PC,P2) are extracted. Note here that although in this example the item configuration and production information plus shipment plan are used to prepare the array IS, other approaches are also employable, one preferred form of which is arranged to pre-register in the storage unit those calculation-targeted item/hub pairs and read them to set in the array IS.

### <Step 903>

In case there is a shipment plan, an operation is performed to assign items needed to execute the plan while making shipment satisfying the designated date and quantity. More specifically, while letting the inventory/work-in-process read out of the inventory/work-in-process storage unit be the allocation target, the so-called material requirements planning (MRP) technique is used to calculate respective requisite quantities. One typical MRP processing method is discussed in the above-cited non-patent literature titled “Theory & Practice of MRP.” An example of the system using MRP scheme is disclosed in JP-A-2000-79542. Concerning the inventory/work-in-process allocated to the shipment plan, the information thereof is held in the memory, and subsequent processing uses a remaining allocation number as the inventory/work-in-process quantity.

Steps 904 and 905 are executed once per expiration of a planned period. As for the planned period setup, currently available methods are employable. Any data that is stored in the storage unit as the information for enabling identification of a start date and end date may be set in the memory from the input unit. This information may alternatively be set in the memory from the data input/setup window 111 being displayed on the monitor screen. Still alternatively, the information may be predefined by means of a software program.

### <Step 904>

Zero (0) is set to an index “p” of the array IS; simultaneously, a sufficiently large number M is set to a variable “lot.” The variable “lot” is a requirement number being set up for the sake of convenience in order to calculate by MRP a maximum producible number. A method of determining the number M may be realized by using any one of the following schemes: setting a value saved in the storage unit by the input unit to the memory, setting it to the memory from the display/input window 111, defining the value by a software program, and defining in advance a program for value calculation. The processing of step 905 is applied to an item “i” and hub “s” which are stored in array IS[p].

### <Step 905>

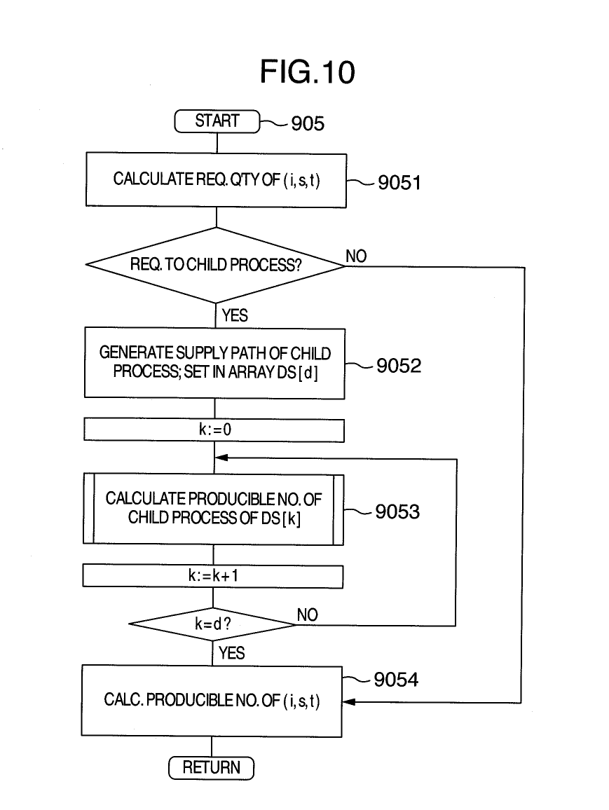

The processing of this step is shown in FIG. 10. This step is the one that adds a supply path generation process to the MRP computation process, wherein step 9051 is equivalent to the MRP calculation, step 9052 is for performing supply path generation processing, and step 9053 is to perform processing for recursively calling the step 905. In step 9051, a pair of work-in-process and unfilled order of item “i” at hub “s” and time “t” is allocated to the requirement number “lot” of item i at hub s and time t while storing non-allocated numbers in a requirement number “nglot.” In the case of the number nglot=0, let a producible number oklot=lot; then, the procedure goes to step 9054.

In the case of nglot>0, a requisition amount nglot is developed to a child process. In case the hub “s” is a production site, the item configuration and production information are used to compute a required quantity and necessary time period of a member “j” needed to manufacture a number of items “i,” which number is equal to the requirement number nglot; then, the inventory and residual order of member j of hub s are allocated, thereby obtaining the requisition amount. In case there are two or more kinds of members with their requisition numbers being larger than zero, a chain of processing operations subsequent to the step 9052 will be performed for a plurality of times equivalent to the number of such members. In case the hub s is not any production site also, similar processing is applied in subsequent steps while letting j=i.

In step 9052, the requirement number “lot” with substitution of the to-be-processed item “j,” hub “s,” required period “t” and requirement number “nglot” are used to determine a supply source hub when the hub s is regarded as a supply destination. First, if there are the item j and hub s in the item/supply-source hub of the supply path information, an operation is performed to acquire a supply source hub “ss” making a pair therewith and register a set of i, s and ss—i.e., (i,s,ss)—in an array DS.

Next, in a case where the plan mode is the nonsteady mode, when a hub “sp” (not equal to “s”) paired with the item “j” in the production information satisfies at least one of the following conditions, a decision is made to presume that the intended supply is available from the hub sp and then store a set (i,s,sp) in the array DS.

A value “t−supply time” is greater than or equal to 1 with the stock/work-in-process amount being larger than zero (0).

A value “t−production time−supply time” is more than one (1).

Note here that the supply time is either a value inputted from the on-screen data input/setup window or a value preregistered to the program or the storage unit. A method of registration to the storage unit is achievable by several approaches, including designing the apparatus to have a predefined value, arranging it to have a storage unit storing therein position information, such as latitude/longitude data, residence or post code data, as part of the hub information and a processor unit operative to presume a time length by a geographic distance to thereby allow the processor unit to obtain a supply time by computation, and designing the apparatus to have a function of displaying on the monitor screen a data setup window for enabling the user to manually input a per-item supply time with designation of a supply source hub and a supply destination hub as shown in FIG. 12.

The processing of step 9053 is repeated for a certain number of times corresponding to the data number of the array DS that was created by the processing stated supra. The step 9053 is for executing the processing of step 905 with respect to a child process (j,sp,t) which is passed as a variable known as argument. Note here that the parameter “t” as used herein is set at a value from which the supply time was subtracted; however, if it is less than zero, an operation is performed for passing it to the next array prior to handover to the processing of step 905 or for regarding it as lead time overrun (production incapability) in the requisite amount calculation of step 9051.

The processing of step 9053 results in acquisition of a producible number “oklot” as a return value, which is stored in the memory while letting it link with the array DS.

At step 9054, an operation is performed to let a total value of those producible numbers “oklot” of all child processes be the producible number from the child process. Next, in accordance with the item configuration of from “i” to “j” as has been developed at step 9051, a producible number of (i,s,t) is obtained and handled as the return value.

The processing of step 905 is iteratively executed with respect to each item/hub set on a per-hub basis, thereby calculating a per-plan period producible number of the item/hub under computation.

### <Step 906>

The per-plan period producible number of computation-targeted item/hub which was calculated at step 905 is output by the output unit 108 to the producible number storage unit 109. Additionally, certain supply paths which are larger than zero in supply source hub's inventory, residual order or producible number is extracted from those generated at step 9052 and then output to the supply path storage unit 105. At this time, in order to distinguish the supply path that was generated at step 9052 from the supply paths that have already been registered, an identifier may be added thereto in the process of outputting. The presence of such identifier makes it possible to generate a supply path whenever the need arises by reading only those having no identifiers upon inputting at step 901 and also makes it possible to read all ones and disable the function of generating a new supply path at step 9052.

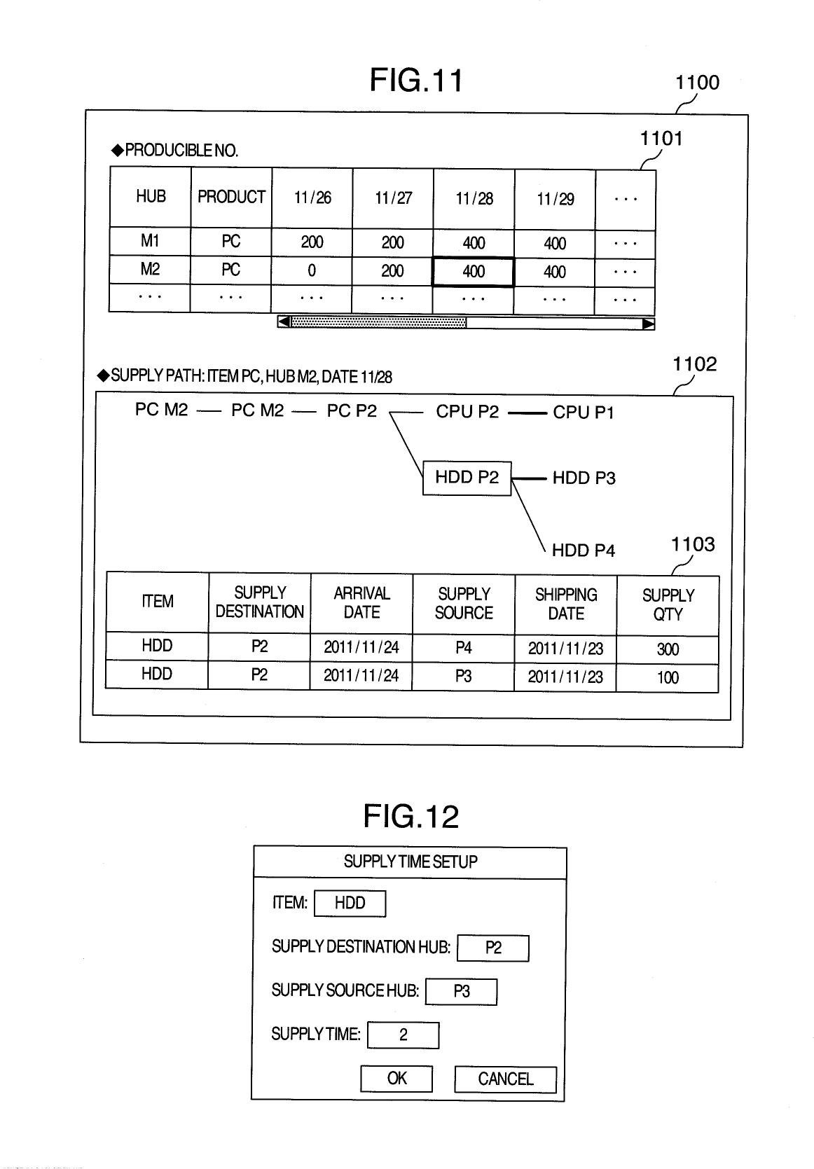

An operation may be performed to display the resultant producible number and supply path in the on-screen data input/setup window 111, thereby permitting creation of a new shipment plan from the producible number and/or revision of the supply time of the supply path. The revised information may be passed by the input unit 106 to the processing unit 107, which recalculates the producible number by using a corrected shipment plan and supply time; alternatively, the information is output to the storage unit without applying recalculation thereto for later use in subsequent computation processes. See FIG. 11, which shows an example that displays the producible number and supply path by means of a popup window 1100 on the monitor screen. Reference numeral 1101 designates a list of producible numbers, wherein per-period producible numbers are displayed in units of calculation-targeted items on a per-hub basis. Upon selection of a numerical value from a list displayed, a supply path is displayed in the form of a tree structure chart. A supply path generated by the processing unit is displayed with visual emphasis being applied thereto—for example, its line is thickened. Upon selection of an item/hub pair of the supply path tree, its relating information is displayed in the form of a table 1103.

Next, a method for recalculating the processing unit's generated supply path while changing the supply time will be described with an example using a display screen. The display device is arranged to have a function of permitting manual entry of data indicative of a supply time as shown in FIG. 12. A data input/setup window of FIG. 12 appears on the display screen in response to the user's selection of a supply path on the screen shown in FIG. 11.

Another example may alternatively be used, which employs a method for displaying the information of supply paths generated in a tabulated list form such as shown by numeral 1103 and for allowing the user to input it directly from this table list. Upon receipt of a “recalculation” command from the input device, i.e., if YES at step 907, the procedure jumps to step 904, followed by execution of its subsequent steps.

As stated above, it is possible, by automated generation of an inter-hub supply path which is not stored in the supply path storage unit, to recognize the limit value of a producible number in nonsteady circumstances, such as in a supply-path shutoff event. This makes it expectable to expedite the production planning while improving demand satisfaction rates.

### Embodiment 2

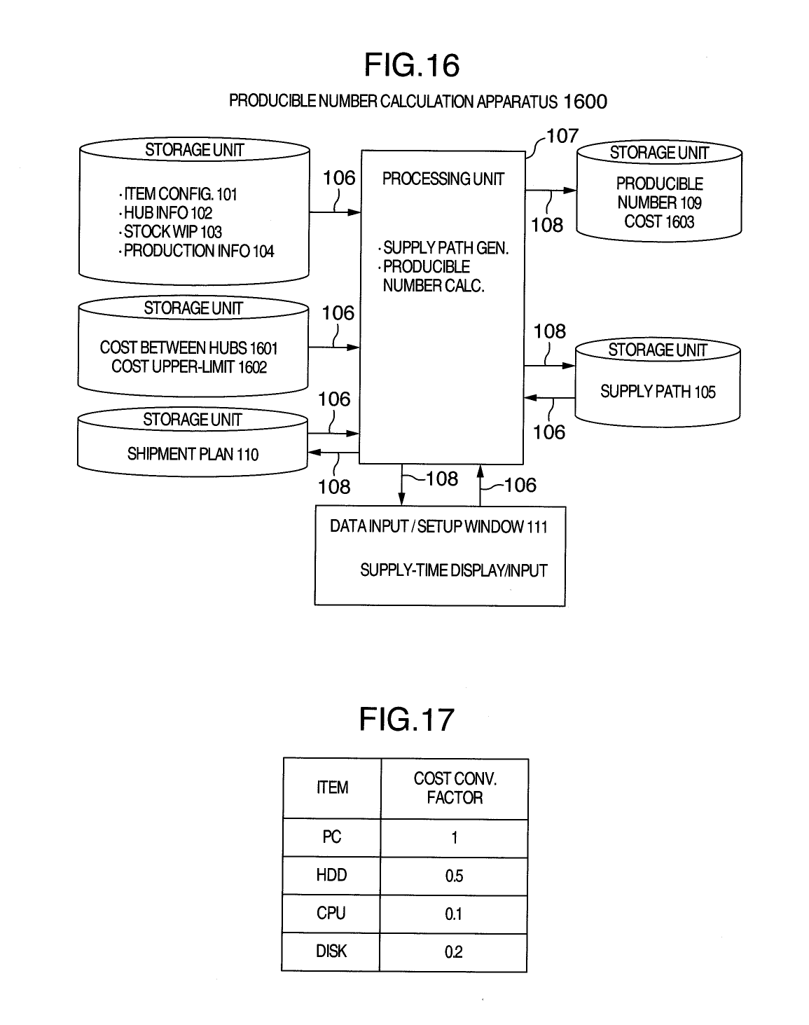

In a second embodiment, an explanation will be given of an example of producible number calculation apparatus which calculates a producible number and cost by using utilizable supply paths. FIG. 16 shows an exemplary configuration of producible number calculation apparatus 1600 in the embodiment 2. Constituent elements or units of apparatus 1600 which are similar in function to those shown in FIG. 1 are designated by the same reference numerals, and their explanations are eliminated herein.

The producible number calculation apparatus 1600 has, in addition to the functional components of the apparatus 100 shown in FIG. 1, an inter-hub cost storage unit 1601 which stores therein a cost between hubs, a cost storage unit 1603 that stores cost data, and a cost upper-limit storage unit 1602 storing, when needed, an upper limit value of product cost on a per-hub basis. A hardware structure of the apparatus 1600 is similar to that of the apparatus 100 shown in FIG. 15.

Next, an operation of the producible number calculation apparatus 1600 of this embodiment will be described by use of the example that has been used for explanation of the operation of apparatus 100.

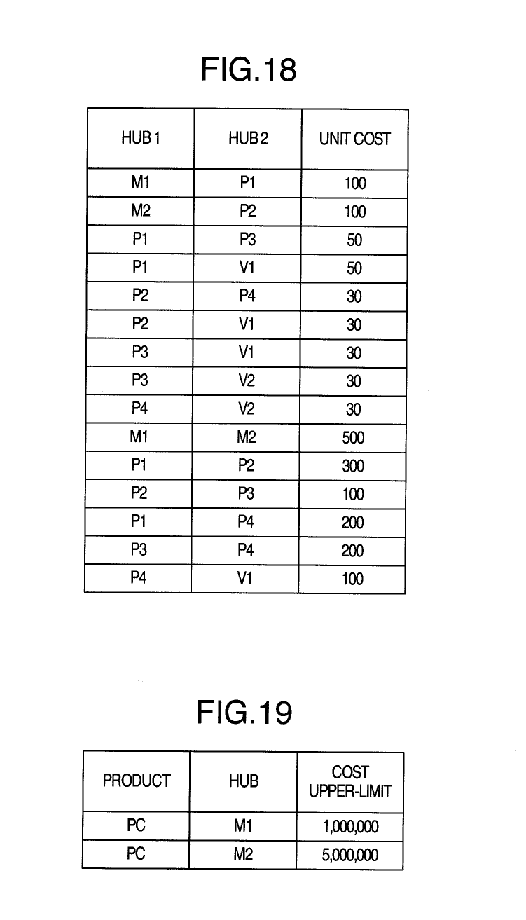

In this embodiment, the interhub cost is assumed to be a cost taken for transportation between hubs, and the explanation below uses an example which stores cost conversion factors of respective items including a finished product and a per-unit cost between hubs. This example assumes that the transportation cost is determined by a distance between hubs and an item to be actually transported therebetween. Other conceivable examples include a way of arranging item/hub-integrated information to have per-item cost data with respect to each route between hubs, and another way of using only interhub cost data in the case of the transfer cost exhibiting no dependency on items. Anyway, the invention is not limited to only the example of FIGS. 17 and 18. Data shown in FIGS. 17-18 are stored in the interhub cost storage unit 1601.

As shown in FIG. 19, a cost upper-limit table stores cost upper-limit values of the product in a hub-by-hub fashion. The data shown in FIG. 19 is saved in the cost upper-limit storage unit 1602. These cost values are typically set up based on actual expenses such as shipping costs of this embodiment, although they are replaceable by other numeric-converted or quantified parameters, such as a quality risk, supply risk, supply time length (lead time) and so forth.

One conceivable example of a method for quantifying a quality rank is arranged to use a per-item defect rate at each hub and a cost needed for countermeasure against defects to perform numerical conversion by multiplication of a defect rate and defect countermeasure cost. The supply risk is also numeric-convertable using a supply stop time and its occurrence probability.

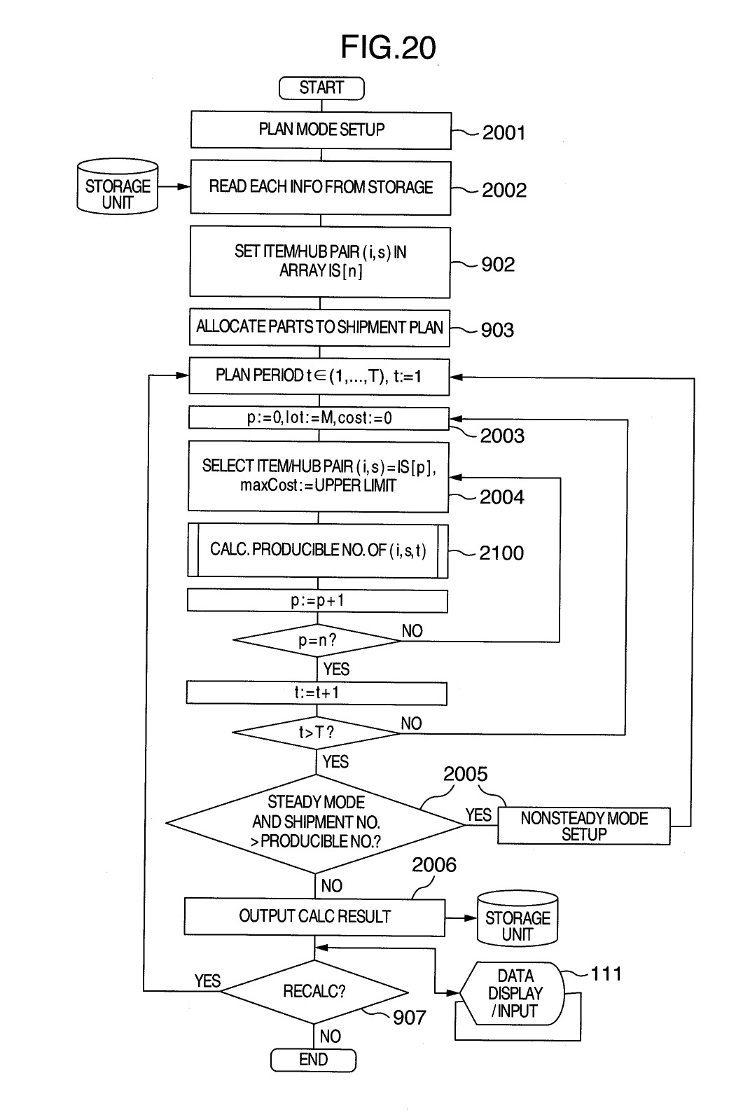

The apparatus 1600 has a data input unit 106, processing unit 107, data output unit 108 and data input/setup window generator 111 and performs processing by using CPU and memory in accordance with a step-by-step procedure shown in FIG. 20. Note here that steps indicated by the same numerals as those shown in FIG. 9 are the same processing contents as corresponding ones of FIG. 9; so, explanations of such steps are omitted herein. Processing operations of steps 2001 to 2006 and 2100 will be described below.

### <Step 2001>

The processing unit 107 sets up a planning mode. As the nature of this planning mode and an operation in “steady” mode are the same as those at the step 900 stated supra, its explanation is eliminated. An operation in “nonsteady” mode is to generate, as need arises, a supply path which is not registered in the supply path storage unit 105 and to compute a producible number and cost. This plan mode will be used in steps 2100 and 2005.

The plan mode may be set up by execution of similar processing to step 900 or, alternatively, by a process of letting an initial value be the steady mode and switching to the nonsteady mode through processing of step 2005 to be later described. In the nonsteady mode of the apparatus 1600, a new supply path is generated other than the already stored supply paths.

### <Step 2002>

The data input unit 106 reads input information 101-105, 110, 1601-1602 needed for computation from the storage units into the memory.

### <Step 2003>

In a similar way to the step 904, an index “p” of array “IS” is set to zero (0), and a variable “lot” is set at a sufficiently large number “M.” At step 2003, a variable “cost” for storage of an accumulated cost value is further defined to have an initial value which is set to “0.” The value of M may be adjusted on a case-by-case basis; for example, in the steady mode, M is set to a product delivery quantity of shipment plan, followed by calculation of a producible number with respect to the shipment plan.

### <Step 2004>

A pair of calculation-targeted item and hub (i,$) is set to a selected value IS[p]—i.e., (i,s)=IS[p]. Then, a cost upper-limit value of item “i” and hub “s” is set to a variable “maxCost.” If there is no cost upper-limit data, a sufficiently large number is set up.

### <Step 2100>

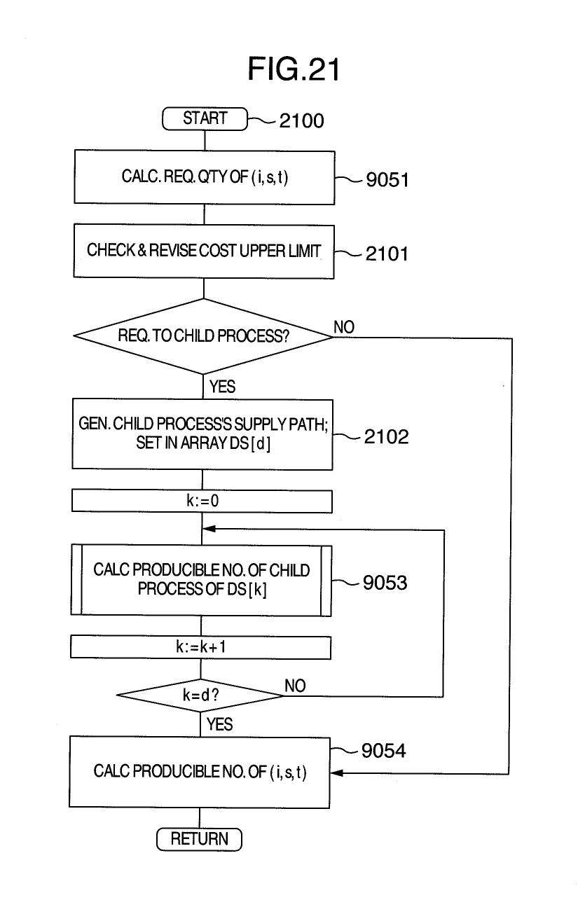

Detailed processing of this step is shown in FIG. 21. Steps indicated by the same reference numerals as those shown in FIG. 10 are the same in processing as the above-stated ones; so, explanations thereof are omitted herein.

In step 2101, a value indicating an upper limit of the supply amount is calculated while taking account of the cost upper-limit value; then, the producible number is revised. More specifically, the following calculations are executed:

An item's per-unit cost “iucost” of an item “i” between paired hubs (s,sp) is calculated by multiplying the cost conversion factor of item i by the per-unit cost between paired hubs (s,sp).

An upper limit value “upperlot” of the supply of a calculation-targeted item i from a supply source hub s is calculated by “(maxCost-cost)/iucost.”

In the case of upperlot<oklot, where “oklot” is the producible number calculated at step 9051, let oklot be upperlot (i.e., oklot=upperlot); then, a requisition amount “nglot” to child process is set at zero (i.e., nglot=0).

The cost value is updated to “cost=cost+(iucostxoklot).”

It is noted that the above-noted equations and those as will be used in subsequent steps are examples in the case of the interhub cost being defined by the cost conversion factor and the cost between hubs, and are not to be construed as limiting the invention.

While the processing at step 2102 is for generating a supply path of child process as in the step 9052, the former is different from the latter in that the cost calculation is performed at the time of determining a supply-capable hub and that a hub which does not exceed the cost upper-limit is entered to the supply-capable hub. More precisely, for a hub “sp” (s) being paired with item “j” from the production information of j, a per-unit cost “iucost” of the item j between hubs s and sp is calculated by multiplying the item i's cost conversion factor and per-unit cost between hubs (s,sp). In the case of iucost+cost<maxCost, at least one unit is suppliable from the hub sp to the destination hub s; thus, a set of i, s and sp i.e., (i,s,sp)—is stored in the array DS.

The processing of step 9053 is repeatedly executed for a certain number of times corresponding to the data number of the array DS as has been created at step 2102. The step 9053 executes the processing of step 2100 with respect to a child process (j,sp,t) that has been passed as an argument. Note that the parameter “t” as used herein is set at a value from which the supply time was subtracted; however, if it is less than zero, an operation is performed for passing it to the next array before handover to the processing of step 2100 or for regarding it as lead time overrun (production incapability) in the requisite amount calculation of step 9051.

### <Step 2005>

In case the planning mode is the steady mode, when the calculation-targeted item/hub pair (i,$) contains at least one with the shipment plan's delivery number being larger than the producible number, the plan mode is switched to nonsteady mode; then, the procedure returns to the processing next to step 2002. This processing return is aimed at increase of the producible number by generation of a supply path that is not defined by the supply path information. When it is desired to output the result of the steady mode, this processing may be moved to a post-stage of step 2006. Optionally, the result of steady mode may be displayed by the display device while enabling reception of a nonsteady mode switch command and a recalculation command from the input device.

### <Step 2006>

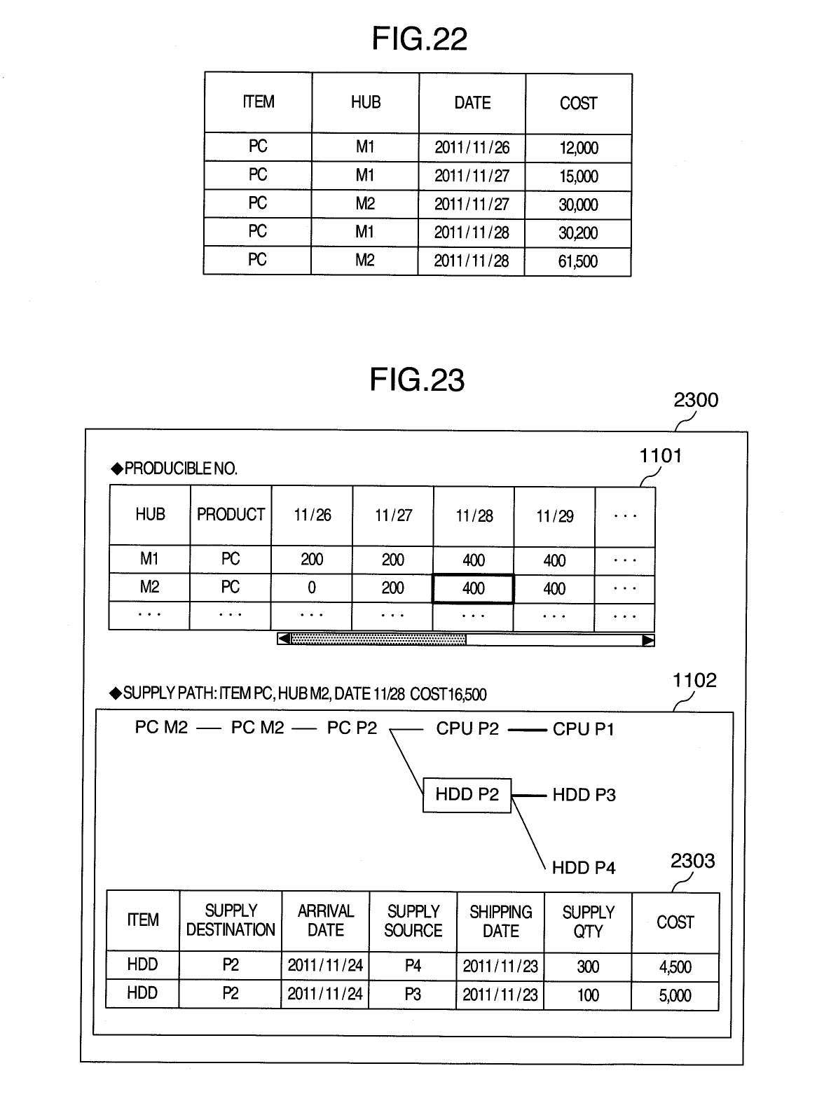

The producible number per plan period of the calculation-targeted item/hub, which was calculated at step 2100, is output by the output unit 108 to the producible number storage 109 while outputting the cost value to the cost storage 1603. An output example of the producible number is shown in FIG. 14 whereas a cost output example is shown in FIG. 22. As the information to be output to the supply path storage unit 105 is the same as that at step 906, its explanation is omitted.

An operation of the functional module for generating the data input/setup window 111 on the display screen is similar to the above-stated embodiment 1 in handling of the producible number and supply path. In this embodiment, further data, such as the cost, cost upper-limit, cost conversion factor and interhub cost, are displayed in the input/setup window 111 for permitting alteration of the cost upper-limit, cost conversion factor and/or interhub cost. There are some available embodiments, one of which is arranged to pass the altered information by the input unit 107 to the processing unit 107 and recalculate a producible number based on the changed cost upper-limit, cost conversion factor and/or interhub, and another of which does not perform such recalculation but outputs it to the storage unit for later use in subsequent process steps. See FIG. 23, which shows an example which displays the producible number, supply path and cost by use of an on-screen popup window 2300. Display image portions indicated by the same reference numerals as those of FIG. 11 are the same in processing as corresponding ones shown in FIG. 11; so, their explanation are eliminated. When a numerical value is chosen from a tabular list 1101, a supply path is displayed in a tree-like form, with costs being also displayed. Upon selection of an item/hub pair of this supply path tree, its related information is displayed in a table form 2303.

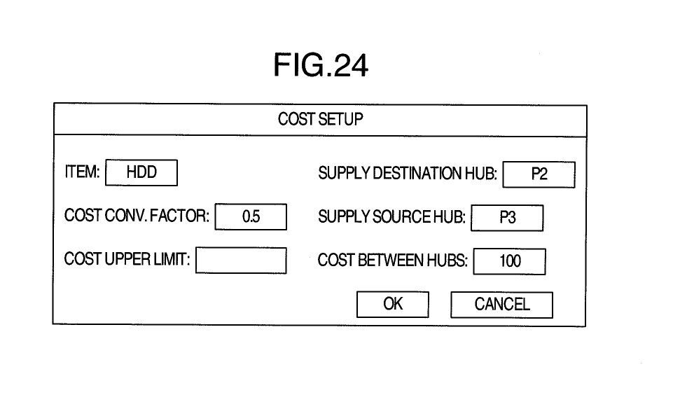

A method for performing recalculation while changing data using the input device will next be described based on an example which uses a display screen. A method of performing recalculation relating to the supply path that was generated by the processing unit while changing the supply time is the same as that of in the above-stated embodiment 1 so that its explanation is omitted. Presented below is an example which changes the cost upper-limit, cost conversion factor and/or interhub cost. The display device is arranged to have a function of displaying on its screen a cost data-inputtable setup window shown in FIG. 24. Another example is also conceivable, which displays the information of once-generated supply path and cost(s) in the table form 2303 and permits the user to input a value(s) directly from the table list. Upon receipt of a recalculation command, the procedure jumps from step 907 along the route of “YES” and then performs processing operations of step 2003 et seq.

Although the scheme for computing the cost upper-limit, cost conversion factor and interhub cost has been stated as the cost calculation methodology, this invention is not limited thereto. The scheme may be replaced by a technique for storing the per-item interhub cost in the storage unit and using it for calculation or a scheme for using this technique together with the above-stated scheme. Furthermore, the apparatus may be designed to have in the storage unit additional cost data indicative of a production cost and inventory cost or else, and add them to the parameter “cost” at step 9051.

As apparent from the foregoing, by adding the cost information to the producible number calculated using a supply path generated, it becomes possible to quantitatively determine whether or not the generated supply path is used to transport the item of interest through comparison of it to a benefit obtainable by satisfaction of the shipment plan and/or a cost to be consumed when using an ordinary supply path.

This invention should not be limited only to the above-stated embodiments 1 and 2 and may include a variety of embodiments or modifications. For example, the above-stated embodiments 1-2 are for detailed explanation of the invention in an understandable way, and the invention is not necessarily limited to the one that has all of the components stated supra. One part of the configuration of an embodiment may be replaced with the configuration of another embodiment; the configuration of an embodiment is alterable so that the configuration of another embodiment is added thereto. Part of the arrangement of each embodiment is modifiable so that another arrangement is added, deleted or replaced therewith. In addition, each said configuration, function, processing unit, processing means or the like is such that a part or entirety thereof may be constituted from hardware by designing it using integrated circuitry for example. Alternatively, the above-stated each configuration and function may be realized by software with the aid of a processor which interprets and executes programs for achieving respective functions. The programs that actualize respective functions and associative information, such as tables, files and like data may be stored in recorder devices including, but not limited to, a semiconductor memory, hard disk drive (HDD) and solid-state drive (SSD) or in storage devices, such as IC card, secure digital (SD) card, digital versatile disc (DVD), etc.

Control lines and data lines indicate those considered to be necessary for explanation, and these do not always indicate all of the real control lines and data lines used in finished products. In reality, almost all configurations may be interpreted as being interconnected together.

It should be further understood by those skilled in the art that although the foregoing description has been made on embodiments of the invention, the invention is not limited thereto and various changes and modifications may be made without departing from the spirit of the invention and the scope of the appended claims.

1. A producible number calculation apparatus for calculating a producible number of a product to be manufactured by combining a plurality of items, said apparatus comprising:
a storage device including,
an item configuration storage unit which stores therein a configuration table of respective items including the product,
a hub information storage unit which stores information on hubs for producing and keeping respective items including the product,
an inventory/work-in-process storage unit which stores inventories and work-in-process quantities of individual hubs of respective items,
a production information storage unit which stories production time lengths of individual hubs of respective items, and
a supply path storage unit which stores a time taken to transfer each item between preset hubs relating thereto, which hubs are selected from those stored in said hub information storage unit; and
a processing unit which calculates a producible number of each item by using the information stored in said storage device, wherein
said processing unit sets up a steady mode or a non-steady mode based on information inputted thereto or the information stored in said storage device, calculates, in the steady mode, the producible number by using a supply path stored in said supply path storage unit, and in the nonsteady mode, sets up a time for transfer of an item between hubs which are not stored in said supply path storage unit and repeatedly computes, from end parts of the item configuration up to the product, a quantity of a parent item having the item as its constituent part when this item is transferred between the hubs by use of the inventory or the work-in-process quantity to thereby calculate the producible number of the product.

2. The producible number calculation apparatus according to claim 1, further comprising:
a display unit which displays the producible number of said product as calculated at said processing unit along with the time taken for transfer between the hubs; and
an input unit which accepts entry of a time for transfer between hubs not being stored in said supply path storage unit, wherein
said processing unit calculates the producible number of said product from the transfer time inputted from said input unit.

3. The producible number calculation apparatus according to claim 1, wherein said processing unit calculates, by use of position information concerning the bubs, the time taken for transfer between hubs not being stored in said supply path storage unit.

4. The producible number calculation apparatus according to claim 1, wherein said processing unit sets up the nonsteady mode when it determines that a supply path stored in said supply path storage unit is in cut-off.

5. The producible number calculation apparatus according to claim 1, wherein said processing unit generates a new supply path by setting up a time for transfer between hubs not being stored in said supply path storage unit, and wherein the newly generated supply path is stored in said supply path storage unit in distinction from those supply paths having already been stored in said supply path storage unit.

6. A computer-readable non-transitory media storing therein a producible number calculation program for calculating a producible number of a product to be manufactured by combining a plurality of items, wherein said program is for use in an apparatus comprising: a storage device including an item configuration storage unit which stores therein a configuration table of respective items including the product, a hub information storage unit which stores information about hubs for producing and keeping respective items including the product, an inventory/work-in-process storage unit which stores inventories and work-in-process quantities of individual hubs of respective items, a production information storage unit which stores production time lengths of individual hubs of respective items, and a supply path storage unit which stores a time taken for transfer of each item between preset hubs relating thereto, which hubs are selected from those stored in said hub information storage unit; and a processing unit which calculates a producible number of each item by using the information stored in said storage device, wherein said program comprises the steps of:
setting up a steady mode or a non-steady mode based on information inputted thereto or the information stored in said storage device;
calculating, in the steady mode, the producible number by using a supply path stored in said supply path storage unit; and
in the nonsteady mode, setting up a time for transfer of an item between hubs which are not stored in said supply path storage unit and repeatedly computes, from end parts of the item configuration up to the product, a quantity of a parent item having the item as its constituent part when this item is transferred between the hubs by use of the inventory or the work-in-process quantity to thereby calculate the producible number of the product.

7. The computer-readable non-transitory media according to claim 6, wherein said apparatus further comprises a display unit which displays the producible number of said product as calculated at said processing unit along with the time taken for transfer between the hubs, and an input unit which accepts entry of a time for transfer between hubs not being stored in said supply path storage unit, and wherein said method further comprises:
calculating the producible number of said product from the transfer time inputted from said input unit.

8. The computer-readable non-transitory media according to claim 6, wherein in the nonsteady mode, position information concerning the bubs is used to calculate the time taken for transfer between hubs not being stored in said supply path storage unit.

9. The computer-readable non-transitory media according to claim 6, wherein the nonsteady mode is set up when it is judged that a supply path stored in said supply path storage unit is in cutoff.

10. The computer-readable non-transitory media according to claim 6, wherein in the nonsteady mode, a new supply path is generated by setting up a time for transfer between hubs not being stored in said supply path storage unit, and wherein the newly generated supply path is stored in said supply path storage unit in distinction from those supply paths having already been stored in said supply path storage unit.

11. A producible number calculation apparatus for calculating a producible number of a product to be manufactured by combining a plurality of items, said apparatus comprising:
a storage device including,
an item configuration storage unit which stores therein a configuration table of respective items including the product,
a hub information storage unit which stores information on hubs for producing and keeping respective items including the product,
an inventory/work-in-process storage unit which stores inventories and work-in-process quantities of individual hubs of respective items,
a production information storage unit which stores production time lengths of individual hubs of respective items,
a supply path storage unit which stores a time taken for transfer of each item between preset hubs relating thereto, which hubs are selected from those stored in said hub information storage unit, and
a hub-to-hub cost storage unit which stores a cost between hubs; and
a processing unit which calculates a producible number of each item and a cost by using the information stored in said storage device, wherein
said processing unit sets up one of a steady mode for calculation of a producible number by using a supply path stored in said supply path storage unit and a nonsteady mode for generating a supply path not being stored in said supply path storage unit to thereby calculate a producible number, calculates, in the steady mode, the producible number by using a supply path being stored in said supply path storage unit, and in the nonsteady mode, sets up a time for transfer of an item between hubs not being stored in said supply path storage unit and repeatedly calculates, from end parts of the item configuration up to the product, a quantity of a parent item having the item as its component and a cost thereof when this item is transferred between the hubs by use of the inventory or the work-in-process quantity to thereby calculate the producible number of the product and the cost.

12. The producible number calculation apparatus according to claim 11, further comprising:
a display unit which displays the producible number of said product and the cost as calculated at said processing unit along with the time taken for transfer between hubs; and
an input unit which accepts entry of a time for transfer between hubs not being stored in said supply path storage unit and also entry of a cost, wherein
said processing unit calculates the producible number of said product and the cost from the transfer time and cost inputted from said input unit.

13. The producible number calculation apparatus according to claim 11, wherein said storage device further includes a cost upper-limit storage unit which stores therein cost upper-limit values of individual hubs of the product, and wherein said processing unit generates in the nonsteady mode a hub-to-hub supply path of an item and performs producible number calculation in such a manner that a cost for production of the product is less than or equal to said cost upper-limit value.

14. The producible number calculation apparatus according to claim 13, wherein said storage device further includes a shipment plan information storage unit which stores therein a per-date hub-by-hub shipment volume of the product, and wherein said processing unit first calculates a producible number in the steady mode and, when this producible number is less than the shipment volume stored in said shipment plan information storage unit, calculates a producible number and a cost in the nonsteady mode.

15. A computer-readable non-transitory media storing a producible number calculation program for calculating a producible number of a product to be manufactured by assembling a plurality of items, wherein said program is for use in an apparatus comprising: a storage device including an item configuration storage unit which stores therein a configuration table of respective items including the product, a hub information storage unit which stores information on hubs for producing and keeping respective items including the product, an inventory/work-in-process storage unit which stores inventories and work-in-process quantities of individual hubs of respective items, a production information storage unit which stores production time lengths of individual hubs of respective items, a supply path storage unit which stores a time taken for transfer of each item between preset hubs relating thereto, which hubs are selected from those stored in said hub information storage unit, and a hub-to-hub cost storage unit which stores a cost between hubs; and a processing unit which calculates a producible number of each item and a cost by using the information stored in said storage device, and wherein said program causes the apparatus to execute processing comprising the steps of:
setting up one of a steady mode for calculation of a producible number by using a supply path stored in said supply path storage unit and a nonsteady mode for generating a supply path not being stored in said supply path storage unit to thereby calculate a producible number;
calculating, in the steady mode, the producible number by using a supply path being stored in said supply path storage unit; and
in the nonsteady mode, setting up a time for transfer of an item between hubs not being stored in said supply path storage unit and repeatedly calculates, from end parts of the item configuration up to the product, a quantity of a parent item having the item as its component and a cost thereof when this item is transferred between the hubs by use of the inventory or the work-in-process quantity to thereby calculate the producible number of the product and the cost.

16. The computer-readable non-transitory media according to claim 15, wherein said apparatus further comprises a display unit which displays the producible number of said product and the cost as calculated at said processing unit along with the time taken for transfer between hubs, and an input unit which accepts entry of a time for transfer between hubs not being stored in said supply path storage unit and also entry of a cost, wherein said method further comprises:
calculating the producible number of said product and the cost from the transfer time and cost inputted from said input unit.

17. The computer-readable non-transitory media according to claim 15, wherein said storage device further includes a cost upper-limit storage unit which stores therein cost upper-limit values of individual hubs of the product, and wherein said method further comprises generating in the nonsteady mode a hub-to-hub supply path of an item in such a manner that a cost for production of the product is less than or equal to said cost upper-limit value and then performing producible number calculation.

18. The computer-readable non-transitory media according to claim 15, wherein said storage device further includes a shipment plan information storage unit which stores therein a per-date hub-by-hub shipment volume of the product, and wherein said method comprises:
first calculating a producible number in the steady mode; and
calculating a producible number and a cost in the nonsteady mode when this producible number is less than the shipment volume stored in said shipment plan information storage unit.
